(19) United States
(12) Patent Application Publication
(10) Pub. No.: US 2015/0175217 A1
(43) Pub. Date: Jun. 25, 2015

(54) ELASTICALLY AVERAGED ALIGNMENT SYSTEMS AND METHODS

(71) Applicant: GM GLOBAL TECHNOLOGY OPERATIONS LLC, Detroit, MI (US)

(72) Inventors: Steven E. Morris, Fair Haven, MI (US); Jennifer P. Lawall, Waterford, MI (US)

(73) Assignee: GM GLOBAL TECHNOLOGY OPERATIONS LLC, Detroit, MI (US)

(21) Appl. No.: 14/134,801

(22) Filed: Dec. 19, 2013

(51) Int. Cl. B62D 27/02

(52) U.S. Cl. CPC B62D 27/023; B29L 2031/30

(57) ABSTRACT

In one aspect, an elastically averaged alignment system is provided. The system includes a first component having an inner surface and an alignment member extending therefrom, and a second component including a standoff having an inner wall at least partially defining an alignment aperture configured to receive the alignment member to couple the first component and the second component. The standoff is configured to engage and support the first component inner surface when the first and second components are coupled. The alignment member is an elastically deformable material such that when the alignment member is inserted into the alignment aperture, the alignment member elastically deforms to an elastically averaged final configuration to facilitate aligning the first component and the second component in a desired orientation.

### FIELD OF THE INVENTION

The subject invention relates to matable components and, more specifically, to elastically averaging matable components for alignment therebetween.

### BACKGROUND

Components, in particular vehicular components which are to be mated together in a manufacturing process, may be mutually located with respect to each other by alignment features that are oversized holes and/or undersized upstanding bosses. Such alignment features are typically sized to provide spacing to freely move the components relative to one another to align them without creating an interference therebetween that would hinder the manufacturing process. One such example includes two-way and/or four-way male alignment features; typically upstanding bosses, which are received into corresponding female alignment features, typically apertures in the form of slots or holes. The components are formed with a predetermined clearance between the male alignment features and their respective female alignment features to match anticipated size and positional variation tolerances of the male and female alignment features that result from manufacturing (or fabrication) variances.

As a result, significant positional variation can occur between two mated components having the aforementioned alignment features, which may contribute to the presence of undesirably large variation in their alignment, particularly with regard to gaps and/or spacing therebetween. In the case where misaligned components are also part of another assembly, such misalignment may also affect the function and/or aesthetic appearance of the entire assembly. Regardless of whether such misalignment is limited to two components or an entire assembly, it can negatively affect function and result in a perception of poor quality. Moreover, clearance between misaligned components may lead to relative motion therebetween, which may cause undesirable noise such as squeaking and rattling, and further result in the perception of poor quality.

### SUMMARY OF THE INVENTION

In one aspect, an elastically averaged alignment system is provided. The system includes a first component having an inner surface and an alignment member extending therefrom, and a second component including a standoff having an inner wall at least partially defining an alignment aperture configured to receive the alignment member to couple the first component and the second component. The standoff is configured to engage and support the first component inner surface when the first and second components are coupled. The alignment member is an elastically deformable material such that when the alignment member is inserted into the alignment aperture, the alignment member elastically deforms to an elastically averaged final configuration to facilitate aligning the first component and the second component in a desired orientation.

In another aspect, a vehicle is provided. The vehicle includes a body and an elastically averaged alignment system integrally arranged with the body. The elastically averaged alignment system includes a first component having an inner surface and an alignment member extending therefrom, and a second component including a standoff having an inner wall at least partially defining an alignment aperture configured to receive the alignment member to couple the first component and the second component. The standoff is configured to engage and support the first component inner surface when the first and second components are coupled. The alignment member is an elastically deformable material such that when the alignment member is inserted into the alignment aperture, the alignment member elastically deforms to an elastically averaged final configuration to facilitate aligning the first component and the second component in a desired orientation.

In yet another aspect, a method of manufacturing an elastically averaged alignment system is provided. The method includes forming a first component having an inner surface and an alignment member extending therefrom, and forming a second component having a standoff that includes an inner wall at least partially defining an alignment aperture configured to receive the alignment member to couple the first component and the second component. The standoff is configured to engage and support the first component inner surface when the first and second components are coupled. The method further includes forming the alignment member from an elastically deformable material such that when the alignment member is inserted into the alignment aperture, the alignment member elastically deforms to an elastically averaged final configuration to facilitate aligning the first component and the second component in a desired orientation.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of an exemplary elastically averaged alignment system;

FIG. 2 is a cross-sectional view of a portion of the system shown in FIG. 1 and before assembly;

FIG. 3 is a cross-sectional view of a portion of the system shown in FIG. 1 and after assembly;

FIG. 4 is a cross-sectional view of an alternative embodiment of a portion of the system shown in FIG. 1 and before assembly; and

FIG. 5 is a side view of a vehicle that may use any of the elastically averaged alignment systems shown in FIGS. 1-4.

### DETAILED DESCRIPTION

The following description is merely exemplary in nature and is not intended to limit the present disclosure, its application or uses. For example, the embodiments shown are applicable to vehicle body panels, but the alignment system disclosed herein may be used with any suitable components to provide elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to the application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. In some embodiments, the elastically deformable component configured to have at least one feature and associated mating feature disclosed herein may require more than one of such features, depending on the requirements of a particular embodiment. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, published as U.S. Pub. No. 2013/0019455, the disclosure of which is incorporated by reference herein in its entirety. The embodiments disclosed above provide the ability to convert an existing component that is not compatible with the above-described elastic averaging principles, or that would be further aided with the inclusion of a four-way elastic averaging system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

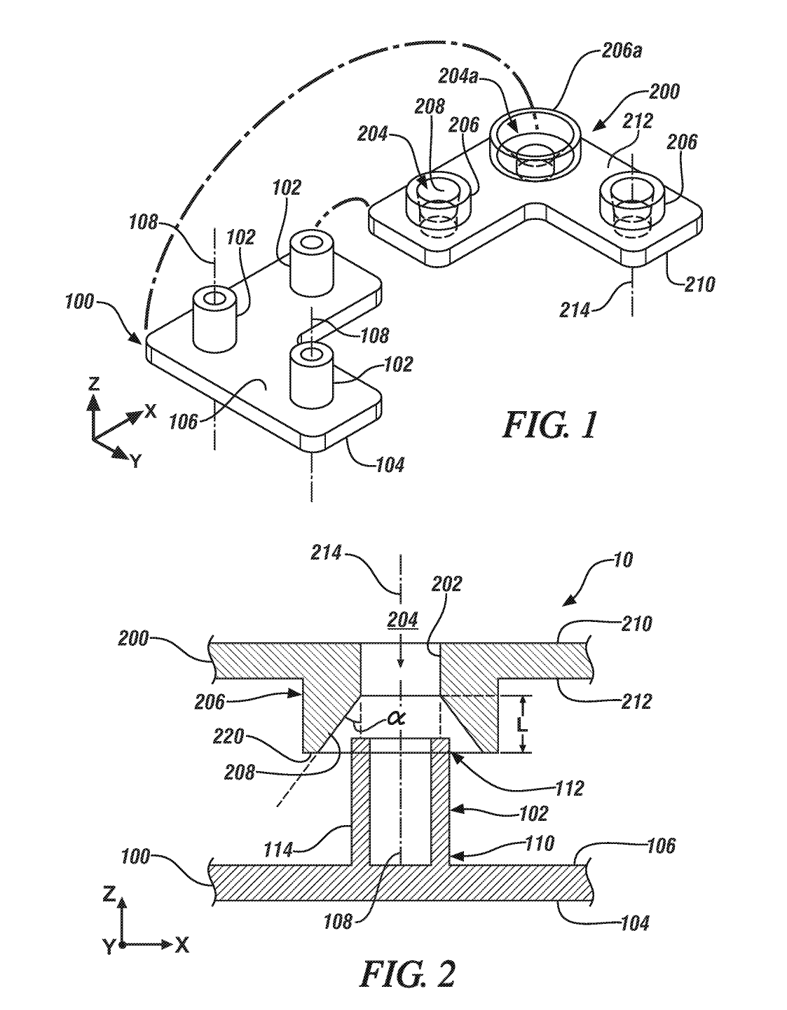

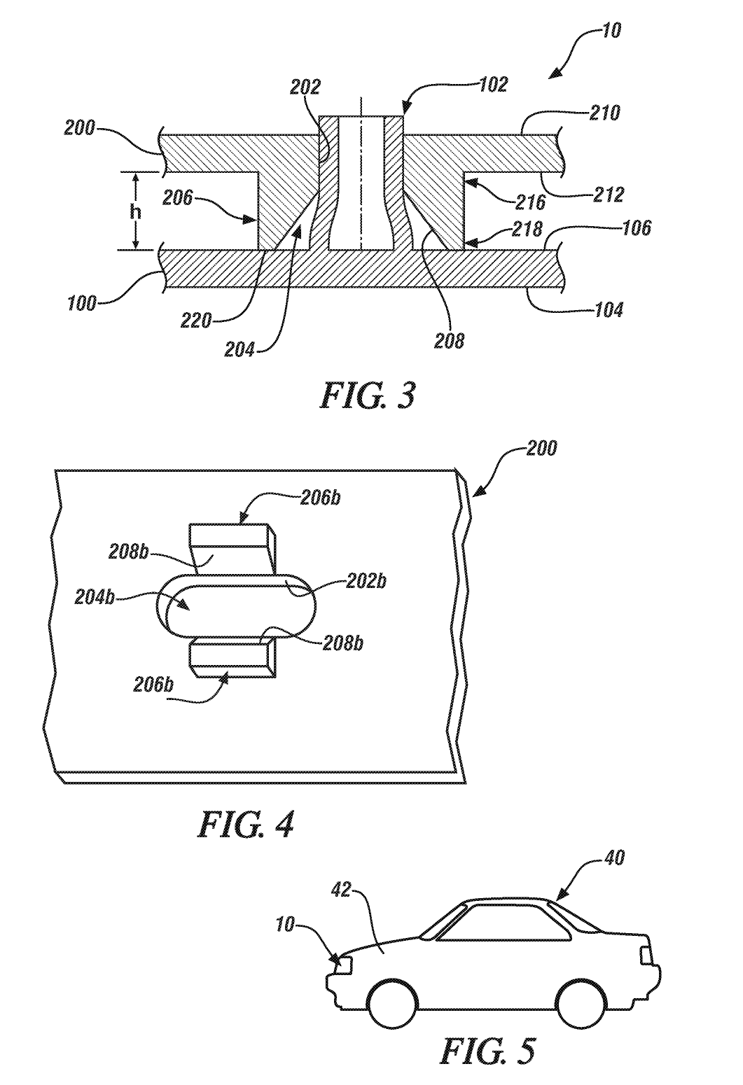

FIG. 1 illustrates an exemplary elastically averaged alignment system 10 that generally includes a first component 100 to be mated to a second component 200. FIG. 2 illustrates a portion of first component 100 and second component 200 before assembly, and FIG. 3 illustrates the portion of first component 100 and second component 200 after assembly.

In the exemplary embodiment, first component 100 includes an elastically deformable alignment member 102, and second component 200 includes an inner wall 202 at least partially defining an alignment aperture 204. Second component 200 also includes a standoff 206 having an inner wall 208 at least partially defining alignment aperture 204. Alignment member 102, alignment aperture 204, and standoff 206 are fixedly disposed on or formed integrally with their respective component 100, 200 for proper alignment and orientation when components 100 and 200 are mated. Although several alignment members 102, alignment apertures 204, and standoffs 206 are illustrated, components 100 and 200 may have any number and combination of corresponding alignment members 102, alignment apertures 204, and standoffs 206. Elastically deformable alignment member 102 is configured and disposed to interferingly, deformably, and matingly engage alignment aperture 204, as discussed herein in more detail, to precisely align first component 100 with second component 200 in two or four directions, such as the +/−x-direction and the +/−y-direction of an orthogonal coordinate system, for example, which is herein referred to as two-way and four-way alignment. Moreover, elastically deformable alignment member 102 matingly engages alignment aperture 204 to facilitate a stiff and rigid connection between first component 100 and second component 200, thereby reducing or preventing relative movement therebetween.

In the exemplary embodiment, first component 100 generally includes an outer face 104 and an inner face 106 from which alignment member 102 extends. Alignment member 102 is a generally circular hollow tube having a central axis 108, a proximal end 110 coupled to inner face 106, and a distal end 112. However, alignment member 102 may have any cross-sectional shape that enables system 10 to function as described herein. In the exemplary embodiment, first component 100 is fabricated from an elastically deformable material such as plastic. However, first component 100 may be fabricated from any suitable material that enables system 10 to function as described herein.

Second component 200 generally includes an outer face 210 and an inner face 212. In the exemplary embodiment, alignment aperture 204 is illustrated as having a generally circular cross-section. Alternatively, alignment aperture 204 may have any shape that enables system 10 to function as described herein. For example, alignment aperture 204 may be an elongated slot (e.g., similar to the shape of elastic tube alignment system described in co-pending U.S. patent application Ser. No. 13/187,675 and particularly illustrated in FIG. 13 of the same), as shown in FIG. 4 as slot 204b. In the exemplary embodiment, second component 200 is fabricated from a rigid material such as plastic. However, second component 200 may be fabricated from any suitable material that enables system 10 to function as described herein.

Standoff 206 is a generally circular, hollow tube having a central axis 214, a proximal end 216 coupled to inner face 212, and a distal end 218. However, standoff 206 may have any cross-sectional shape that enables system 10 to function as described herein. For example, as shown in FIG. 1, a standoff 206a may have a cross-sectional shape similar to a large annulus, or the standoff may have a cross-sectional shape similar to slotted alignment aperture 204b shown in FIG. 4. Additionally, the standoff may be formed by a plurality of tabs or segments generally forming a desired cross-section, as shown in FIG. 4 as standoff 206b. Standoff inner wall 208 is oriented at an angle “α” with respect to central axis 214, and sidewall 208 may be angled a distance “L” along only a portion of the entire height “h” of standoff 206 (FIGS. 2-3) or may be angled along the entire height “h” of standoff 206 (not shown).

Moreover, angle “α” and length “L” may be variably designed to adjust the amount of force required to insert alignment member 102 into alignment aperture 204. For example, as angle “α” is increased, the force required for alignment member insertion is decreased, and vice versa. As length “L” is increased, standoff 206 provides a longer lead-in for alignment member 102, which facilitates reducing the amount of force required for alignment member insertion. Additionally, a longer length “L” and/or larger angle “α” increase the relative area for alignment member insertion, thereby facilitating a lesser degree of precision when initially aligning components 100 and 200 for assembly. As such, standoff inner wall 208 helps guide alignment member 102 into its final position within alignment aperture 204.

Further, inner wall 202 and/or standoff 206 may be elastically deformable to facilitate added elastic average tuning of system 10. For example, inner wall 202 and/or a surrounding portion of second component 200 may be made from an elastically deformable material and/or have a smaller thickness or gauge than the rest of component 200. As such, during insertion of alignment member 102 into alignment aperture 204, inner wall 202 and/or a surrounding portion of component 200 elastically deforms to an elastically averaged final configuration to facilitate aligning first component 100 and second component 200 in a desired orientation. Accordingly, first component tube thickness, standoff tube thickness, and second component material and/or gauge may be adjusted to tune the elastic average mating between first component 100 and second component 200.

While not being limited to any particular structure, first component 100 may be a decorative trim component of a vehicle with the customer-visible side being outer face 104, and second component 200 may be a supporting substructure that is part of, or is attached to, the vehicle and on which first component 100 is fixedly mounted in precise alignment.

To provide an arrangement where elastically deformable alignment member 102 is configured and disposed to interferingly, deformably and matingly engage inner wall 202 of alignment aperture 204, the diameter of at least a portion of alignment aperture 204 is less than the diameter of alignment member 102, which necessarily creates a purposeful interference fit between the elastically deformable alignment member 102 and alignment aperture 204. Further, standoff inner wall 208 forms a chamfer to facilitate insertion of alignment member 102. As such, when inserted into alignment aperture 204, portions of the elastically deformable alignment member 102 elastically deform to an elastically averaged final configuration that aligns alignment member 102 with the alignment aperture 204 in four planar orthogonal directions (the +/−x-direction and the +/−y-direction. Where the alignment aperture is a slot, the alignment member is aligned in two planar orthogonal directions (the +/−x-direction or the +/−y-direction).

In the exemplary embodiment, standoff 206 is oriented at the edge of inner wall 202 and provides a support platform at a height “h” below second component inner face 212. First component inner face 106 rests upon a standoff end face 220 when elastically deformable alignment member 102 is configured and disposed to interferingly, deformably and matingly engage alignment aperture 204. Stated alternatively, standoffs 206 are disposed and configured to provide a final relative position between alignment aperture 204 and elastically deformable alignment member 102 at an elevation “h” above inner face 212.

FIG. 4 illustrates another exemplary embodiment of second component 200. In the exemplary embodiment, component 200 includes a slotted-aperture 204b defined by an inner wall 202b, and two opposed standoffs 206b having angled inner wall 208b.

While FIG. 1 depicts three elastically deformable alignment members 102 in a corresponding aperture 204 to provide four-way alignment of first component 100 relative to second component 200, it will be appreciated that the scope of the invention is not so limited and encompasses other quantities and types of elastically deformable alignment elements used in conjunction with the elastically deformable alignment member 102 and corresponding aperture 204.

In view of the foregoing, and with reference now to FIG. 5, it will be appreciated that an exemplary embodiment of the invention includes elastically averaging alignment system 10 implemented in a vehicle 40 having a body 42 with an elastically averaging alignment system 10 as herein disclosed integrally arranged with body 42. In the embodiment of FIG. 5, elastically averaging alignment system 10 is depicted forming at least a portion of a front grill of vehicle 40. However, it is contemplated that an elastically averaging alignment system 10 as herein disclosed may be utilized with other features or components of the vehicle, such as, for example, exterior body trim, interior trim, inserts, bezels, and decorative trim.

An exemplary method of fabricating elastically averaged alignment system 10 includes forming first component 100 with at least one alignment member 102. Second component 200 is formed with inner wall 202 and standoff 206, which includes inner wall 208 at least partially defining alignment aperture 204 with inner wall 202. However, second component 200 may optionally exclude inner wall 202. The lead in on standoff 206 may be formed with desired length “L” and sidewall 208 is formed at desired angle “α”. At least one of alignment member 102, standoff 206, and inner wall 208 are formed to be elastically deformable such that when alignment member 102 is inserted into alignment aperture 204, at least one of alignment member 102, standoff 206, and inner wall 208 elastically deform to an elastically averaged final configuration to facilitate aligning first component 100 and second component 200 in a desired orientation.

Elastically averaged mating assembly systems and methods are described herein. The systems generally include a first component with an elastically deformable alignment member positioned for insertion into an alignment aperture of a second component. The alignment aperture is at least partially defined by a standoff formed on the second component. The standoff includes angled inner walls to facilitate reception of the alignment member into the alignment aperture. The length of the standoff and the angle of the inner walls are variable to control the amount of force required to insert the alignment member into the alignment aperture. The mating of the first and second components is elastically averaged over a corresponding pair or pairs of elastically deformable alignment members and alignment apertures to precisely mate the components in a desired orientation. As such, the systems and methods provide a system that is easily assembled, tunable for desired applications, reduces or eliminates the need for fasteners to mate the components, and provides a premium show surface.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment system comprising:
a first component comprising an inner surface and an alignment member extending therefrom; and
a second component comprising a standoff having an inner wall at least partially defining an alignment aperture configured to receive the alignment member to couple the first component and the second component, the standoff configured to engage and support the first component inner surface when the first and second components are coupled;
wherein the alignment member is an elastically deformable material such that when the alignment member is inserted into the alignment aperture, the alignment member elastically deforms to an elastically averaged final configuration to facilitate aligning the first component and the second component in a desired orientation.

2. The system of claim 1, wherein the standoff is tubular.

3. The system of claim 1, wherein the second component further comprises a second inner wall further defining the alignment aperture.

4. The system of claim 1, wherein the first component comprises more than one of the elastically deformable alignment member and the second component comprises more than one of the standoff and the alignment aperture, the more than one elastically deformable alignment members being geometrically distributed with respect to respective ones of the more than one standoffs and alignment apertures, such that portions of the elastically deformable alignment member of respective ones of the more than one elastically deformable alignment members, when engaged with respective ones of the more than one standoffs and alignment apertures, elastically deform to an elastically averaged final configuration that further aligns the first component with the second component in at least two of four planar orthogonal directions.

5. The system of claim 1, wherein at least a portion of the standoff inner wall defines a chamfer.

6. A vehicle comprising:
a body; and
an elastically averaged alignment system integrally arranged with the body, the elastically averaged alignment system comprising:
a first component comprising an inner surface and an alignment member extending therefrom; and
a second component comprising a standoff having an inner wall at least partially defining an alignment aperture configured to receive the alignment member to couple the first component and the second component, the standoff configured to engage and support the first component inner surface when the first and second components are coupled;
wherein the alignment member is an elastically deformable material such that when the alignment member is inserted into the alignment aperture, the alignment member elastically deforms to an elastically averaged final configuration to facilitate aligning the first component and the second component in a desired orientation.

7. The system of claim 6, wherein the standoff is tubular.

8. The system of claim 6, wherein the second component further comprises a second inner wall further defining the alignment aperture.

9. The vehicle of claim 6, wherein the first component comprises a plurality of the alignment members extending from the inner surface, and the second component comprises a plurality of the standoffs at least partially defining one alignment aperture, each of the alignment members, when inserted into one of the alignment apertures, elastically deforms to an elastically averaged final configuration such that a manufacturing variance of each of the first and second components is averaged over the total of the alignment members.

10. A method of manufacturing an elastically averaged alignment system, the method comprising:
forming a first component having an inner surface and an alignment member extending therefrom;
forming a second component having a standoff that includes an inner wall at least partially defining an alignment aperture configured to receive the alignment member to couple the first component and the second component, the standoff configured to engage and support the first component inner surface when the first and second components are coupled; and
forming the alignment member from an elastically deformable material such that when the alignment member is inserted into the alignment aperture, the alignment member elastically deforms to an elastically averaged final configuration to facilitate aligning the first component and the second component in a desired orientation.

11. The method of claim 10, further comprising forming the standoff as tubular.

12. The method of claim 10, further comprising forming a second inner wall in the second component, the second inner wall further defining the alignment aperture.

13. The method of claim 10, wherein said forming a first component comprises forming a first component with an inner surface and a plurality of alignment members extending therefrom, and wherein said forming a second component comprises forming a second component having a plurality of standoffs that include an inner wall at least partially defining an alignment aperture.

14. The method of claim 13, further comprising forming the first and second components such that the plurality of alignment members are geometrically distributed with respect to respective ones of the plurality of standoffs and respective alignment aperture, such that portions of the elastically deformable alignment member of respective ones of the plurality of elastically deformable alignment members, when engaged with respective ones of the plurality of standoffs and alignment apertures, elastically deform to an elastically averaged final configuration that further aligns the first component with the second component in at least two of four planar orthogonal directions.

15. The method of claim 10, further comprising forming a chamfer with at least a portion of the standoff inner wall.
